(19) United States
(12) Patent Application Publication
(10) Pub. No.: US 2006/0053000 A1
(43) Pub. Date: Mar. 9, 2006

(54) Natural language question answering system and method utilizing multi-modal logic

(76) Inventors: Dan I. Moldovan, Dallas, TX (US); Marta Tatu, Dallas, TX (US)

Correspondence Address: JACKSON WALKER LLP, 2435 NORTH CENTRAL EXPRESSWAY, SUITE 600, RICHARDSON, TX, 75080, US

(21) Appl. No.: 11/246,621

(22) Filed: Oct. 7, 2005

Related U.S. Application Data
(63) Continuation-in-part of application No. 10/843,178, filed on May 11, 2004.
(63) Continuation-in-part of application No. 10/843,177, filed on May 11, 2004.
(60) Provisional application No. 60/616,879, filed on Oct. 7, 2004.

(51) Int. Cl. G06F 17/27

(52) U.S. Cl. 704/9

(57) ABSTRACT

A multi-modal natural language question answering system and method comprises receiving a question logic form, at least one answer logic form, and utilizing semantic relations, contextual information, and adaptable logic.

### CROSS REFERENCE TO RELATED APPLICATIONS

This application is a Continuation-in-Part of U.S. patent application Ser. No. 10/843,178 filed May 11, 2004, entitled NATURAL QUESTION ANSWERING SYSTEM AND METHOD UTILIZING A LOGIC PROVER, and is also a Continuation-in-Part of U.S. patent application Ser. No. 10/843,177 filed May 11, 2004 entitled “NATURAL LANGUAGE QUESTION ANSWERING SYSTEM AND METHOD UTILIZING ONTOLOGIES,” and claims priority of U.S. Provisional Patent Application Ser. No. 60/616,879 filed Oct. 7, 2004 entitled SYSTEM, METHOD, AND COMPUTER READABLE MEDIUM FOR MULTIMODAL QUESTION ANSWERING.

### BACKGROUND OF THE INVENTION

The present invention is related to natural language processing, and, more specifically to a natural language question answering system and method utilizing a logic prover.

Automatic Natural Language Processing (NLP) for question answering has made impressive strides in recent years due to significant advances in the techniques and technology. Nevertheless, in order to produce precise, highly accurate responses to input user queries, significant challenges remain. Some of these challenges include bridging the gap between question and answer words, pinpointing exact answers, accounting for syntactic and semantic word roles, producing accurate answer rankings and justifications, as well as providing deeper syntactic and semantic understanding of natural language text.

The present invention overcomes these challenges by providing an efficient, highly effective technique for text understanding that allows the question answering system of the present invention to automatically reason about and justify answer candidates based on statically and dynamically generated world knowledge. By allowing a machine to automatically reason over and draw inferences about natural language text, the present invention is able to produce answers that are more precise, more accurate and more reliably ranked, complete with justifications and confidence scores.

### SUMMARY OF THE INVENTION

The present invention comprises a natural language question answering system and method utilizing multi-modal logic.

In one embodiment, a method, system and computer readable medium providing natural language question answering comprises receiving a question logic form, at least one answer logic form, and utilizing a contextual index to provide an answer.

In another embodiment, a method system and computer readable medium providing natural language question answering comprises receiving a question logic form, at least one answer logic form, and utilizing semantic relations to provide an answer.

In another embodiment, a method system and computer readable medium providing natural language question answering comprises receiving a question logic form, at least one answer logic form, and utilizing an inference mechanism to provide an answer.

### BRIEF DESCRIPTION OF THE DRAWINGS

FIG. 1a depicts a question answering system according to a preferred embodiment of the present invention;

FIG. 1b depicts a question answering system with logic prover according to a preferred embodiment of the present invention;

FIG. 2 depicts lexical chains according to a preferred embodiment of the present invention;

FIG. 3 depicts a Question Answering Engine according to a preferred embodiment of the present invention;

FIG. 4a depicts a logic prover according to a preferred embodiment of the present invention;

FIG. 4b depicts a logic form transformer according to a preferred embodiment of the present invention;

FIG. 4c depicts an axiom builder according to a preferred embodiment of the present invention;

FIG. 4d depicts a question logic form axioms according to a preferred embodiment of the present invention;

FIG. 4e depicts an answer logic forms axioms according to a preferred embodiment of the present invention;

FIG. 4f depicts an extended WordNet axiom according to a preferred embodiment of the present invention;

FIG. 4g depicts an NLP axioms according to a preferred embodiment of the present invention;

FIG. 4h depicts a lexical chain axiom according to a preferred embodiment of the present invention;

FIG. 4i depicts a justification according to a preferred embodiment of the present invention;

FIG. 4i′ depicts a justification with relaxation according to a preferred embodiment of the present invention;

FIG. 4i″ depicts a relaxation according to a preferred embodiment of the present invention; and

FIG. 4j depicts an answer re-ranking according to a preferred embodiment of the present invention.

### DETAILED DESCRIPTION OF THE INVENTION

The question answering module 48 also receives from the semantic relations module 36 semantic relation tuples 38 and from the context extraction module 542 the contextual indexes XX. Using all these inputs, the question answering module 48 produces a list of ranked answers that are related to the natural language user query 56. These answers are either passed back to the user as answers 53 or passed to the logic prover module 50 as ranked answers 52. The logic prover module 50 passes the ranked answers input 52 and the natural language user query 56 to the word sense disambiguator module 24. The word sense disambiguator module 24 uses these inputs as well as the syntactic parser 12, named entity recognizer 16 and part of speech tagger 20 to create and pass back annotated parse trees 39. The logic prover module 50 passes the annotated parse trees 39 to the semantic relations module 36 and receives back semantic relation tuples 38 and to the context extraction module 542 which outputs the context predicates 558. In addition, the logic prover module 50 produces word tuples 34 which it passes to the lexical chains module 32. The lexical chains module 32 returns lexical chains 35 to the logic prover module 50. Using these inputs, the logic prover module 50 uses the reasoning mechanism of the logic chosen and outputted by the logic selector module 572 based on the (input given by the logic prover module 50) to arrive at a set of re-ranked answers 53 and their associated justifications 60. The answer justifications 60 are passed out of the logic prover module 50 to the user. The re-ranked answers 53 are passed out of the logic prover module to the question answering module 48 which passes them back to the user as re-ranked answers 53.

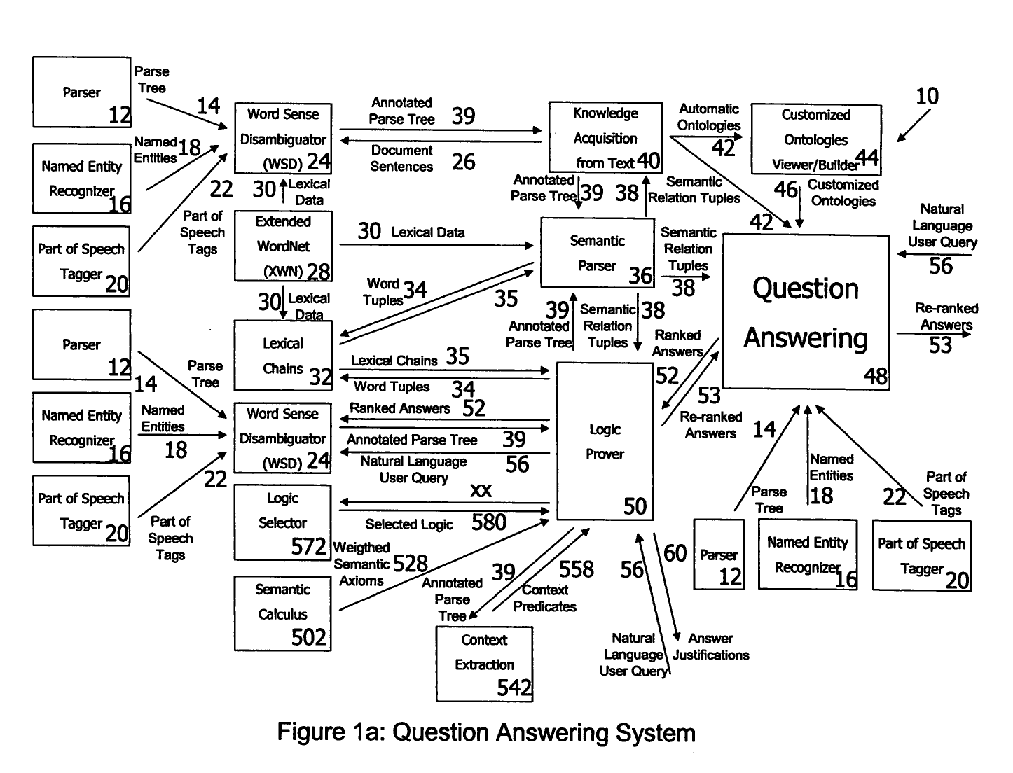

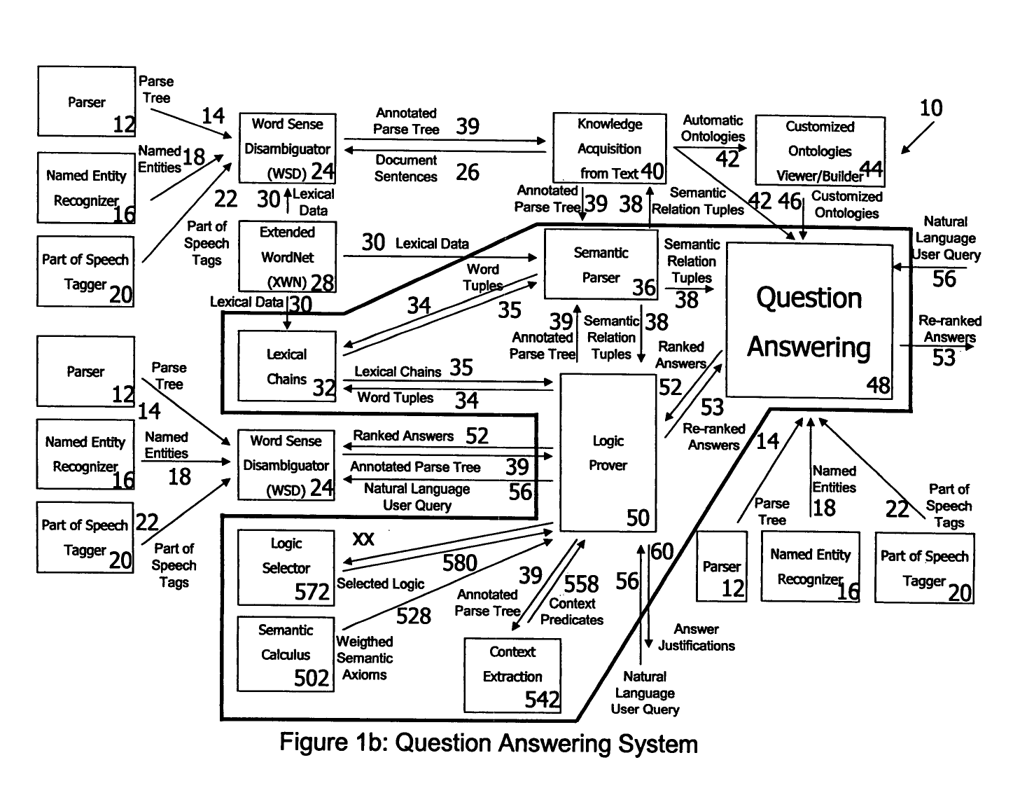

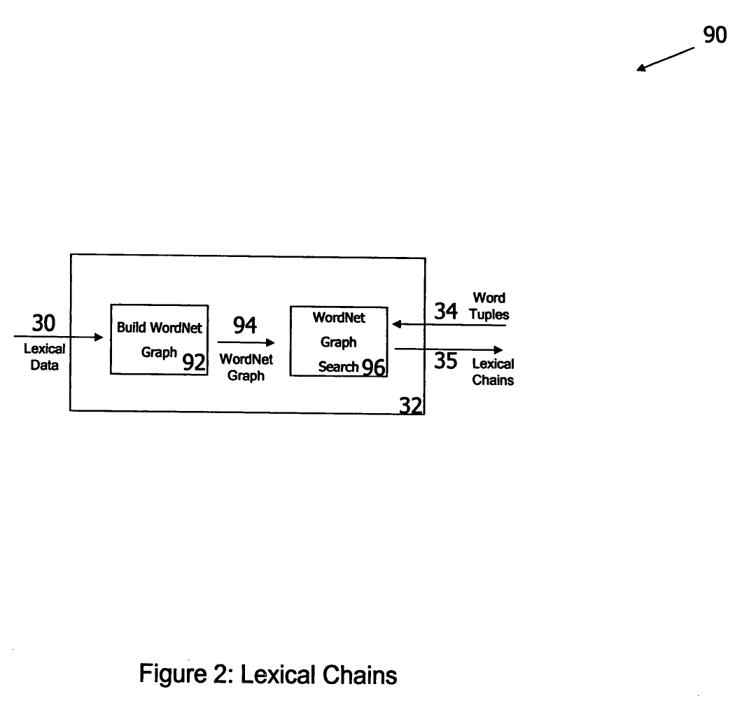

Referring now to FIG. 1b, the multimodal question answering system 10 with logic prover comprises: the question answering module 48, the semantic relation system 36, the context extraction module 542, the logic selector module 572, the logic prover system 50 and the lexical chain system 32.

The utilized axioms are at least one of a following axiom from a group consisting of: lexical chain axioms, semantic axioms, dynamic language axioms, and static axioms, wherein the lexical chain axioms are based on the lexical chains and the semantic axioms combine two or more semantic relations. The utilized lexical chain axioms and the utilized dynamic language axioms are created. The dynamic language axioms including at least one of: question logic form axioms, answer logic form axioms, question based natural language axioms, answer based natural language axioms, and dynamically selected extended lexical information axioms, and wherein the static axioms include at least one of: common natural language axioms, world knowledge axioms, semantic axioms based on the semantic combinations between two or more semantic relations and statically selected extended lexical information axioms.

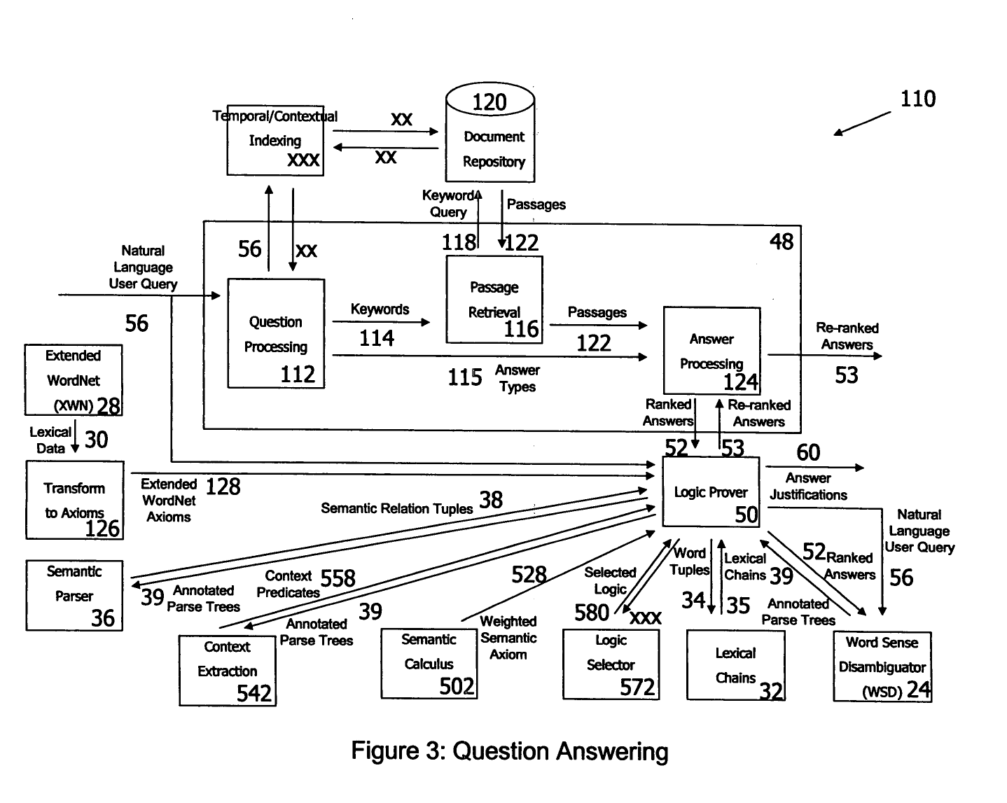

Referring now to FIG. 3, a question answering system 110 is depicted which includes the question answering module 48. The question answering module 48 takes as input a natural language user query 56 which goes into a question processing module 112, the question processing module 112 selects from the natural language user query select words that it considers important in order to answer the question. These are output as keywords 114 from the question processing module. In addition, the question processing module 112 determines and outputs answer types 115. The keywords 114 are passed into a passage retrieval module 116 which creates a keyword query which is output 118 to a document repository 120 by using the keywords 114 and the contextual indexes XX outputted by the contextual indexing module XX. To ensure that all passages relevant to a contextually constrained question are retrieved it is necessary to index the context information in a document. The approach is to scan each document in the document repository 120 for its contextual information, for example, time stamp for temporal contexts, as well as any underspecified or relative references to the contexts, in the case of temporal contexts, references to time. For exemplification, we shall consider the temporal context and the time dependent question “Who lead the NHL in playoff goals in June 1998?” which targets facts that are rooted in an absolute time. A date resolution module processes all underspecified and relative dates to accurately anchor these temporal references in a calendar year. The resolved references as well as the document time stamp are indexed and made searchable for time dependent queries. The context field consists of a (year, month, day, hour, minute, second) tuple, where any member in the tuple is optional. For the question above the query issued by the passage retrieval module 116 to the document repository 120 uses T(1998,06,D,H,M,S) for the above sample question. For questions involving a time range, the query is translated into a disjunction of time operators. As an example, “What Chinese Dynasty was during 1412-1431?” translates to (_organization) AND (chinese) AND (dynasty) AND (T(1412,M,D,H,MN,S) OR T(1413,M,D,H,MN,S) OR . . . OR T(1431,M,D,H,MN,S)). The document repository 120 contains contextually indexed documents in multiple formats that contain information the system will use to attempt to find answers. The document repository 120, based on the keyword query, will return as output passages 122 to the passages retrieval module 116. These passages are related to the input query by having one or more keywords and keyword alternatives in them. They also satisfy the contextual constraints of the question, for example a time range. Because questions requiring temporal understanding are not currently solvable, the usage of contextual indexing has its technical advantages: retrieving answer passages with relative or underspecified context information and discarding contextual inaccurate answers. Passages 122 are passed out from the passage retrieval module 116 to an answer processing module 124. The answer processing module 124 uses these passages 122 as well as the answer types, 115, to perform answer processing in an attempt to find exact, phrase, sentence and paragraph answers from the passages. The answer processing module 124 also ranks the answers it finds in the order it determines is the most accurate. These ranked answers are then passed out as output 52 to the logic prover module 50.

The logic prover module 50 takes as input the ranked answers 52, the natural language user query 56, and the extended WordNet axioms 128 from an extended WordNet axiom transformer 126. It passes the ranked answers 52 and natural language user query 56 to and receives annotated parse trees 39 from the word sense disambiguator module 24. Likewise, passes out word tuples 34 to the lexical chains module 32 and receives back lexical chains 35. Then, the logic prover module 50 passes the annotated parse trees 39 to the semantic relations module 36 which will return the semantic relation tuples 38 and to the context extraction module 542 from which it receives the context predicates. The logic prover module 50 then uses the reasoning mechanism within the logic elected by the logic selector module 572 to produce the output answer justifications 60 and a re-ranking of the input ranked answers as output 53. These re-ranked answers are passed back to answer processing module 124 and returned out of the Question Answering Engine 48 as re-ranked answers 53.

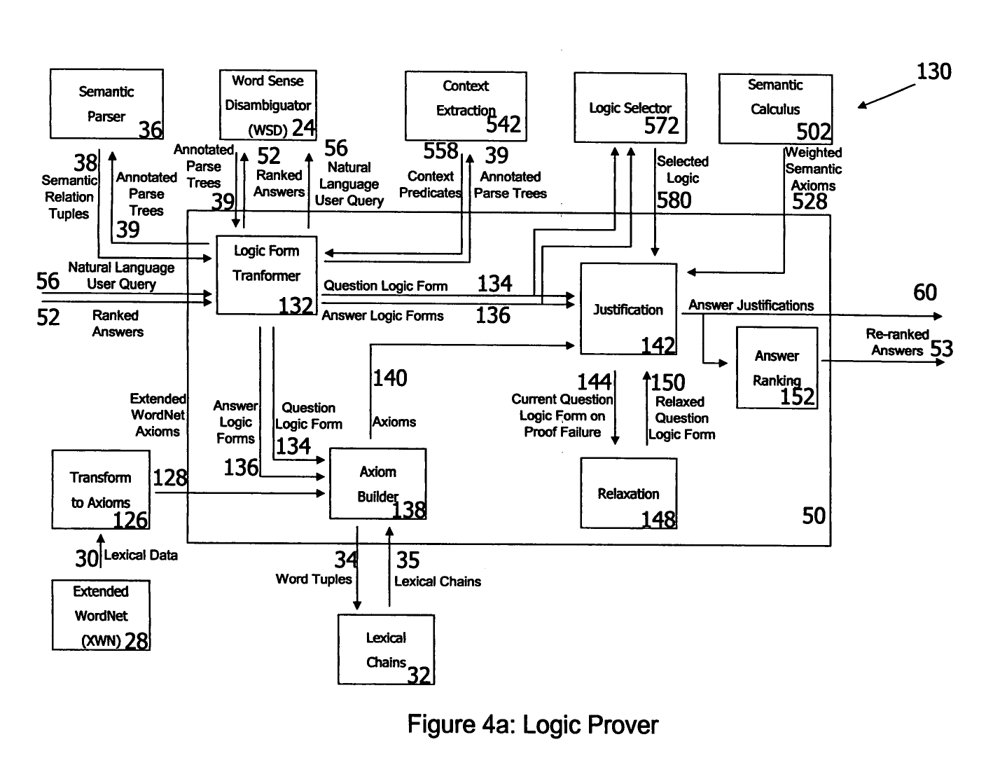

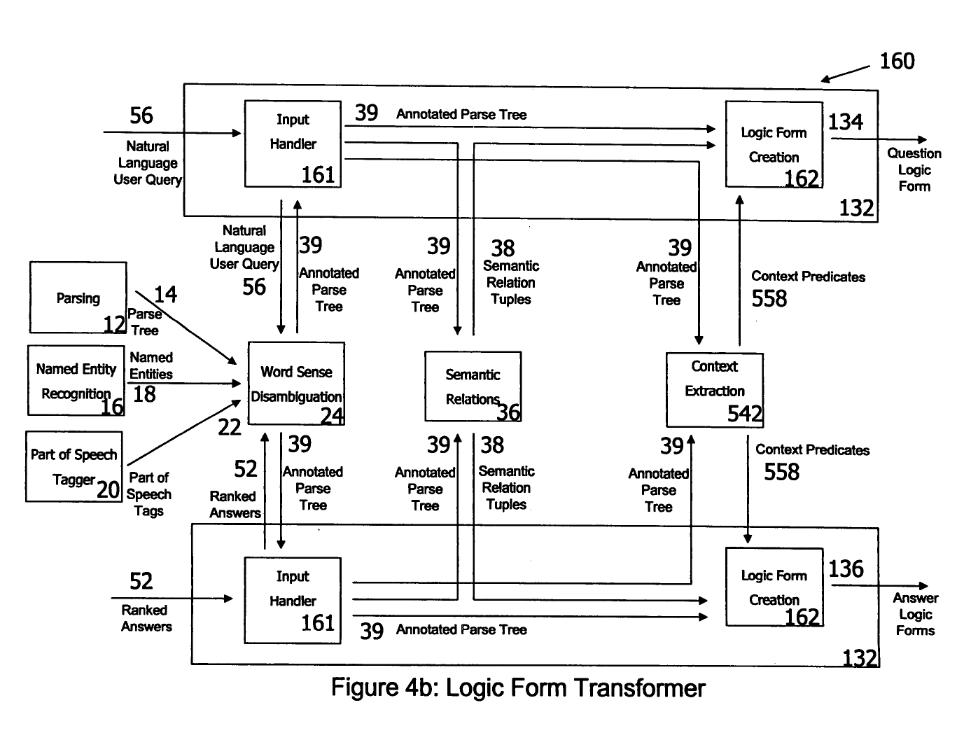

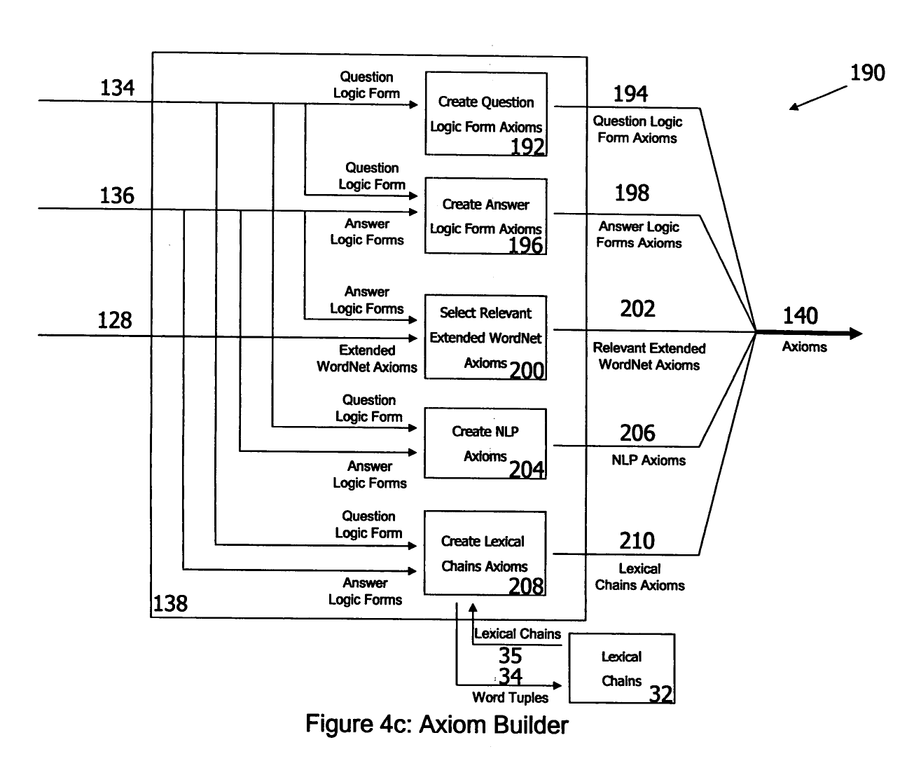

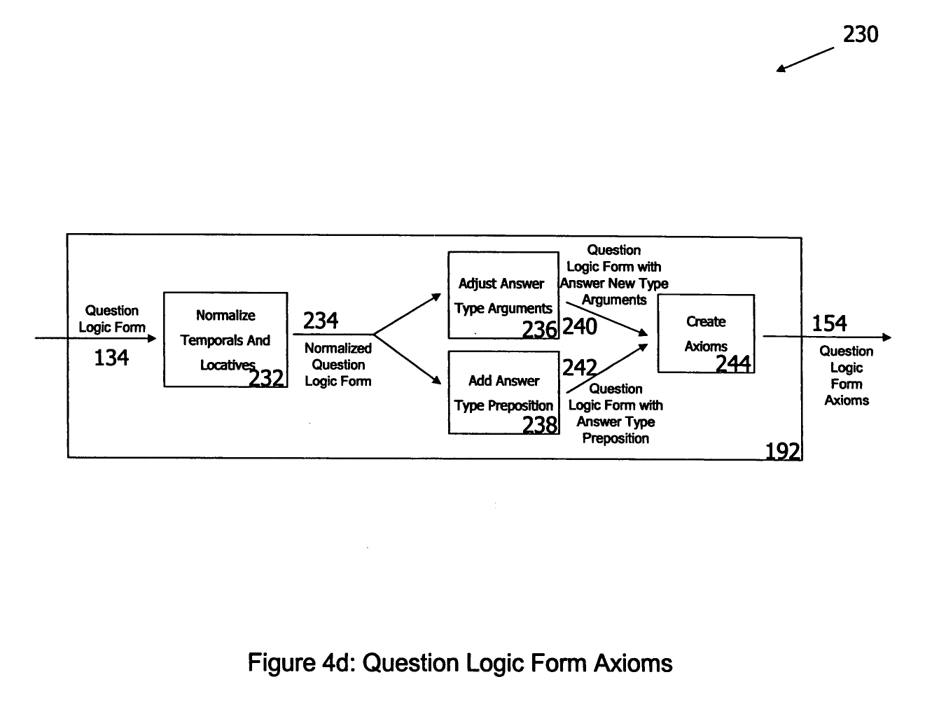

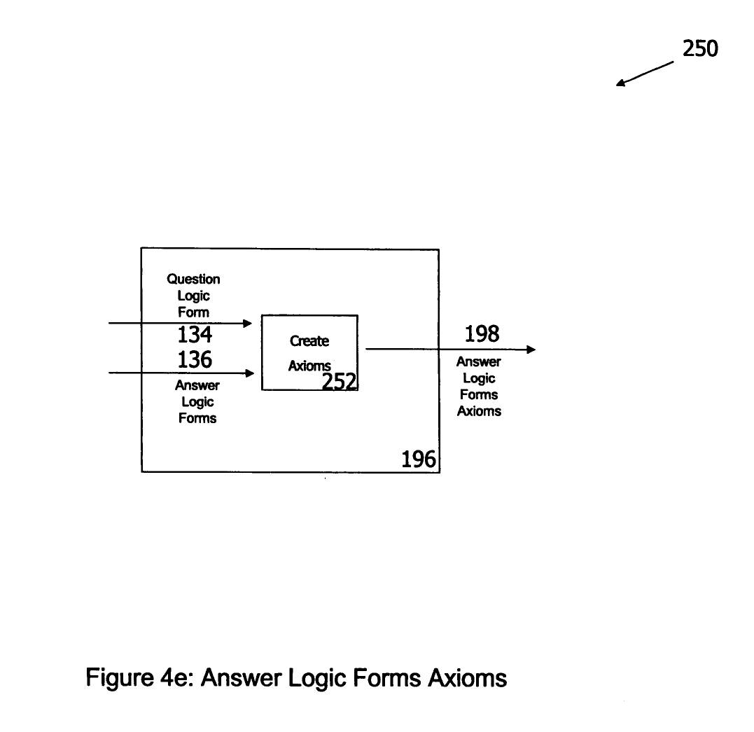

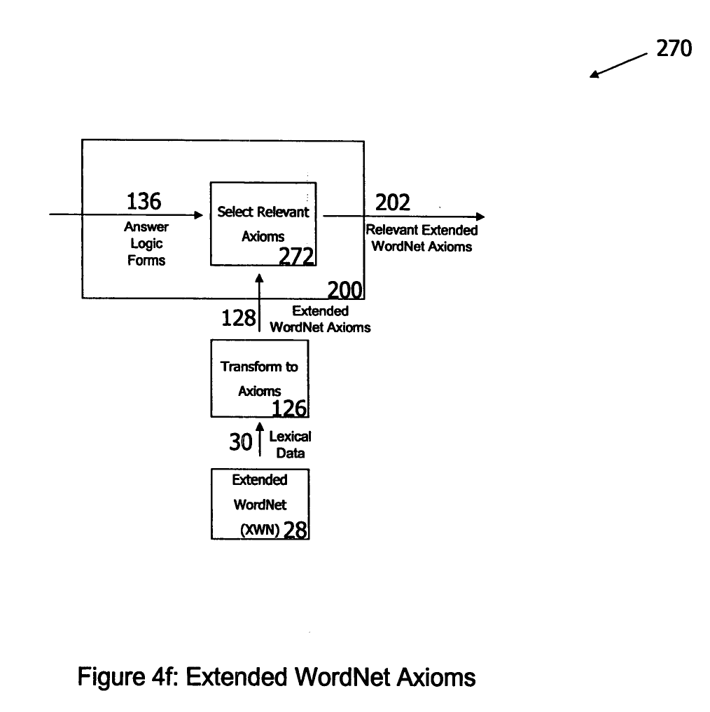

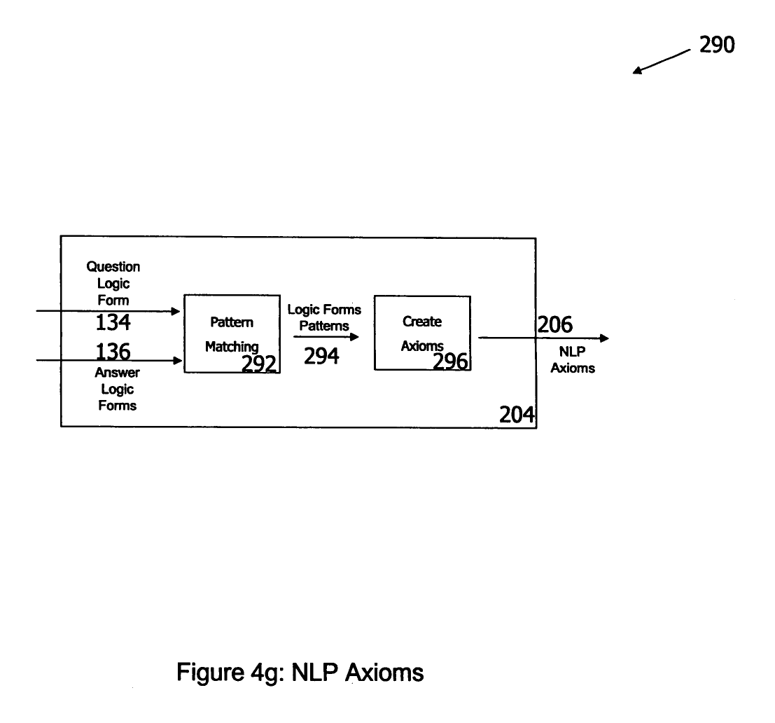

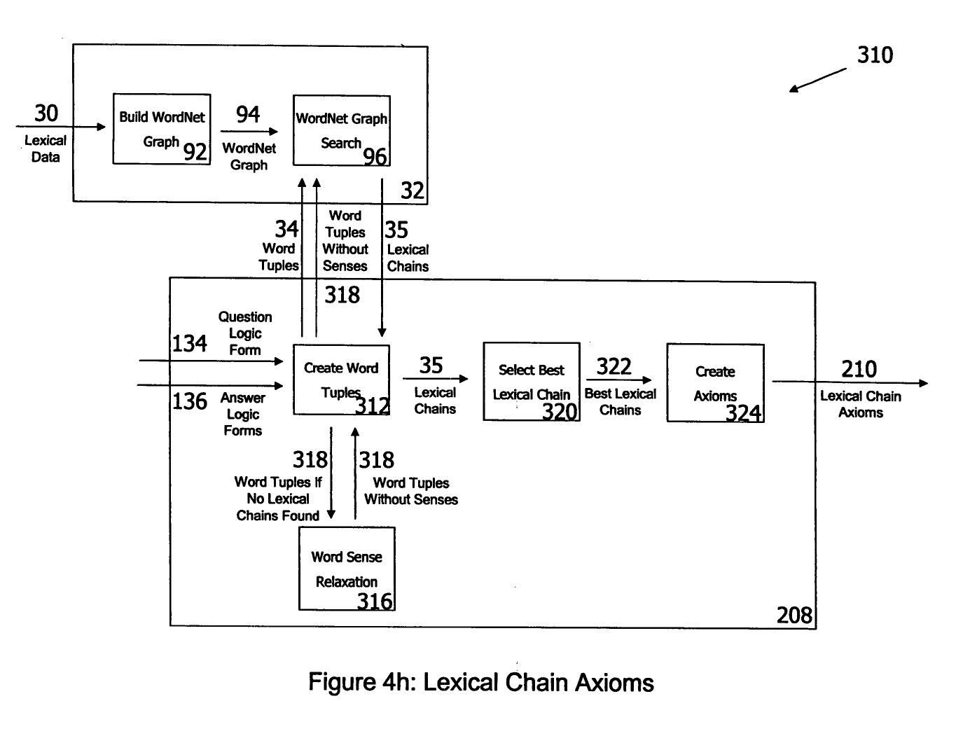

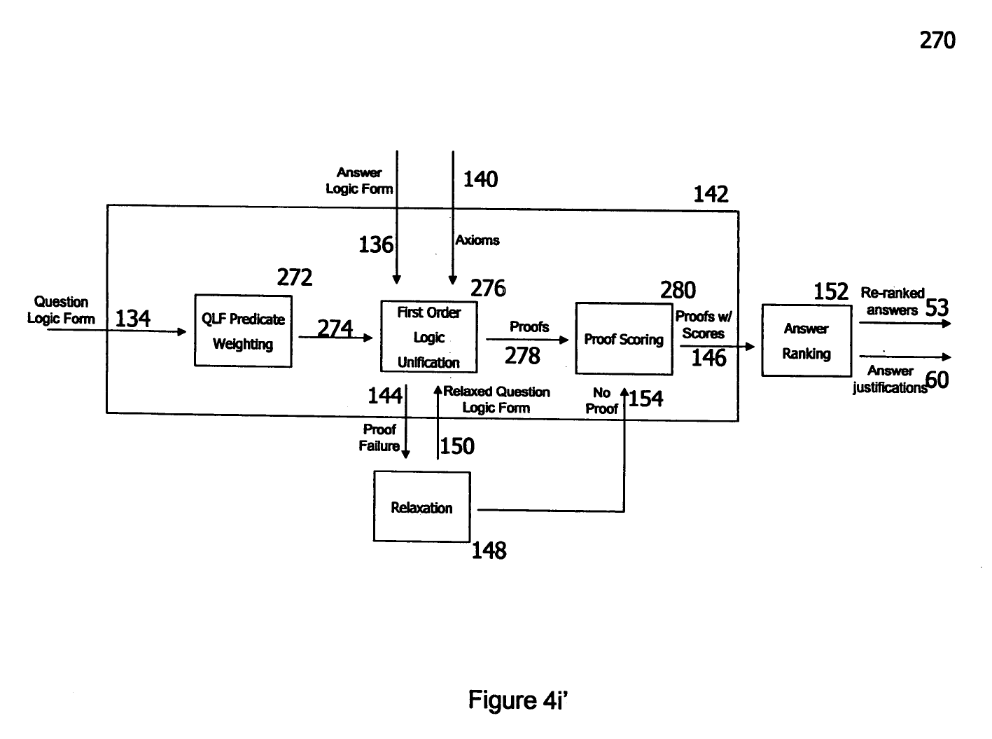

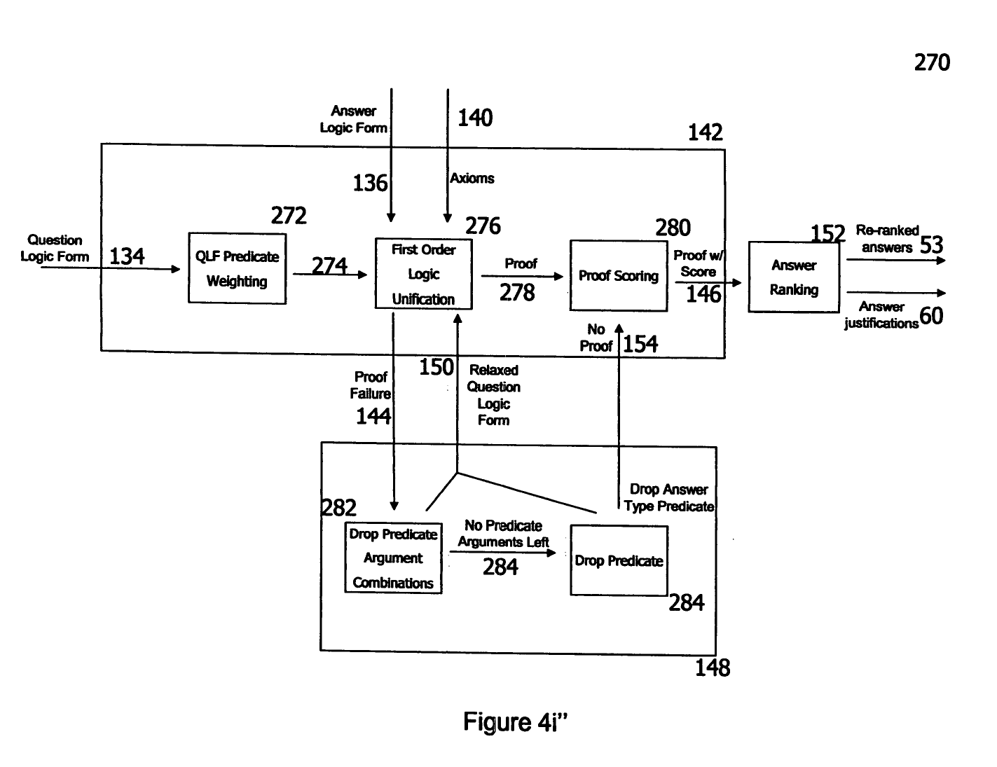

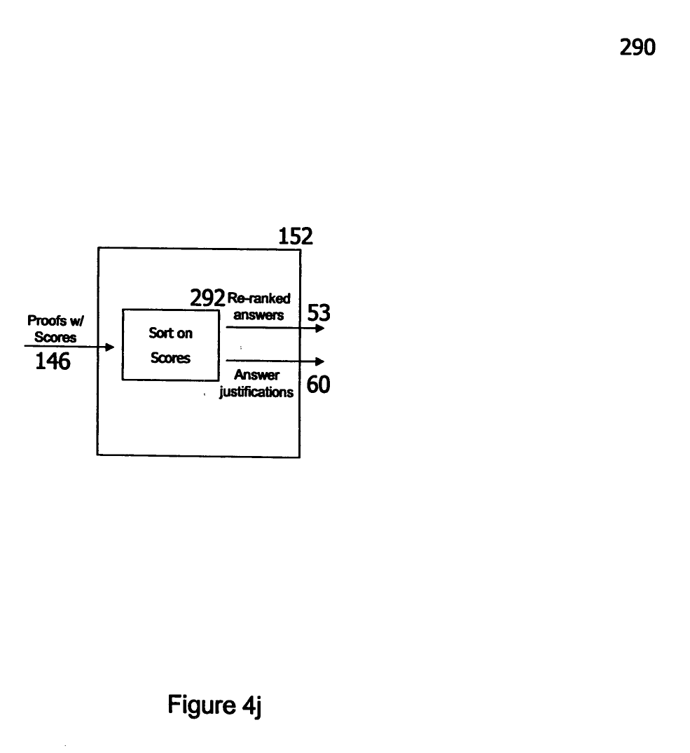

Referring now to FIG. 4a, a logic prover system 130 is presented which includes the logic prover module 50. The logic prover module 50 takes as input a natural language user query 56 and the ranked answers 52. These inputs are passed into a logic form transformer module 132. The logic form transformer 132 passes the ranked answers 52 and natural language user query 56 to and receives annotated parse trees 39 from the word sense disambiguator module 24. Likewise, it passes the annotated parse trees 39 to and receives semantic relation tuples 38 from the semantic relations module 36. It also passes the annotated parse trees 39 to and receives context predicates 558 from the context extraction module 542. Using these inputs, the logic form transformer module 132 transforms the natural language user query 56 and the ranked answers 52 into logic forms. These logic forms consist of question logic forms based on the natural language user query 56 and one or more answer logic forms based on each of the input ranked answers 52. The outputs from the logic form transformer 132 are answer logic forms 136 and question logic form 134. These outputs 136 and 134 are passed to an axiom builder module 138.

The axiom builder module 138 also takes as input extended WordNet axioms 128 which are created by an extended WordNet axiom module 126. This module 126 takes as input the lexical data 30 from the extended WordNet module 28. The axiom builder outputs word tuples 34 to a lexical chain module 32. The axiom builder module 138 receives from the lexical chain module 32 lexical chains as output 35. The axiom builder then creates axioms based on the logic forms, the lexical chains and the extended WordNet axioms. These axioms are output 140 to the justification module 142. The justification module 142 also takes as input the question logic form 134 and the answer logic forms 136 from the logic form transformer 132 and the logic whose reasoning mechanism will be used from the logic selector module 572. This module chooses the appropriate logic based on the question logic form 134 and the answer logic forms 136. The justification module 142 performs the justification within the chosen logic between the question logic form 134 and each answer logic form 136 using the axioms 140 and the weighted semantic axioms 528 received from the semantic calculus module 502. If the justification module 142 is able to find a justification, this justification is passed out as output 60, answer justifications. However, if the justification module 142 is unable to unify the question logic form 134 with the answer logic form 136, it performs a relaxation procedure.

In one embodiment of the present invention, a method for ranking answers to a natural language query comprises receiving natural language information at a first module (such as the logic form transformer 132), outputting logic forms to a second module and to a third module (such as the axiom builder 138 and the justification module 142), receiving lexical chains and axioms based on extended lexical information at the second module, receiving semantic axioms based on the extensive semantic information at the third module, receiving selected ones of the axioms and other axioms at the third module, determining whether at least one of the natural language information is sufficiently equivalent to another one of the natural language information, and outputting a justification based on the determining.

The natural language information referenced above includes a user input query, ranked answers related to the query, semantic relations and context information related to the query and to the ranked answers; the logic forms are at least one question logic form and at least one answer logic form, and are based on the natural language information; the received lexical chains are based on word tuples related to the logic forms; the received contextual information is based on the . . . related to the logic forms; the received axioms are static; the selected ones of the axioms are based on the at least one answer logic form; and the other axioms include at least one of: question logic form axioms, answer logic form axioms, natural language axioms, and lexical chain axioms.

The system 10 of the present invention utilizes software or a computer readable medium that comprises instructions for receiving natural language information at a first module, receiving lexical chains and axioms based on the natural language information and extended lexical information at the second module, receiving semantic axioms based on combinations of two or more semantic relations and the logic selected based on the given input at the third module and outputting a justification based on semantic equivalence of the natural language information, wherein the extended lexical information determines a relationship between words in the natural language information, the semantic axioms augment the semantic knowledge extracted from the natural language information and the logic selected is based on the natural language information.

Referring now to FIG. 4b, a logic form transformer system 160 is depicted which includes a logic form transformer module 132. The logic form transformation module 132 takes as input the natural language query 56 which gets passed to a input handler module 161. The input handler passes the natural language user query 56 to the word sense disambiguator 24 and receives in return an annotate parse tree 39. The annotated parse tree 39 is passed to the logic form creation module 162, to the semantic relations/parser module 36, which passes the extracted semantic relation tuples 38 to the logic form creation module 162 as well as to the context extraction module 542 which passes the identified contextual predicates 558 to the logic form creation module 162. The logic form creation module 162 uses the annotated parse tree 39, semantic relation tuples 38, and the context predicates 558 to create a question logic form 134 and passes it out of the logic form transformer 132. Question logic forms consists of predicates based on the input natural language user query 56 containing the words, named entities, parts of speech, word senses, arguments representing the sentence structure, semantic relations identified between the words, and the contexts present in the question.

The logic form transformer module 132 also takes as input ranked answers 52 which are passed to an input handler module 161. The input handler module 161 passes the ranked answers 52 to the word sense disambiguator 24 and receives in return annotate parse trees 39. The annotated parse trees 39 are passed to the logic form creation module 162, to the semantic relations/parser module 36, which passes the extracted semantic relation tuples 38 to the logic form creation module 162 as well as to the context extraction module 542 which passes the identified contextual predicates 558 to the logic form creation module 162. The logic form creation module 162 uses the annotated parse trees 39, semantic relation tuples 38, and the context predicates 558 to create answer logic forms 136 and pass them out of the logic form transformer 132. Answer logic forms consists of predicates based on the input ranked answers 52 containing the words, named entities, parts of speech, word senses, and arguments representing the sentence structure, semantic relations identified between the words, and the different contexts present in each ranked answer 52.

Referring now to FIG. 4i, a justification system 330 is presented which includes the justification module 142. The justification module 142 takes as input the question logic form 134 which is passed into a question logic form predicate weighting module 332. The question logic form weighting module weights the individual predicates from the question logic form and passes them on as weighted question logic form 334 to a reasoning mechanism module 336. The justification module 142 also takes as input answer logic forms 136, axioms 140, weighted semantic axioms 528 from the semantic calculus module 502, and the selected logic 580 from the logic selector module 572 which takes as input the question logic form 134 and the answer logic forms 136. These are passed into the reasoning mechanism module 336. The reasoning mechanism module 336 then performs the subsumption using the input axioms 140 and the weighted semantic axioms 528 to produce justifications (proofs) between the question logic form 134 and the answer logic forms 136. These proofs are passed as output 338 from the reasoning mechanism module 336 into a proof scoring module 340.

Referring now to FIG. 4i′, the justification system 330 is shown with a relaxation module 148. The reasoning mechanism module 336 interfaces with a relaxation module 148 when performing the subsumption algorithm of the selected logic 580. If it is unable to find a justification between the question logic form and an answer logic form, the question logic form is passed as output 144 to the relaxation module 148. The relaxation module 148 then performs relaxation on the question logic form which is passes back as output 150 to the first order logic unification module 336. The first order logic unification module 336 then re-calls the subsumption algorithm using the relaxed logic form and the original answer logic form. If no proof is found, then the relaxation is performed again to relax the question logic form further. This process continues until either a proof is found or the question logic form can be relaxed no more.

Referring now to FIG. 4i″, the justification system 330 is presented with relaxation module 148 and relaxation sub-modules 342 and 346. To perform relaxation, the relaxation module 148 takes as input from the reasoning mechanism module 336 the question logic form 144 which is passed to the drop predicate argument combination module 342. The drop predicate argument combination module 342 then drops predicate argument combinations and passes the relaxed question logic form 150 to the reasoning mechanism module 336. If a predicate has already had all its arguments dropped, then the drop predicate argument combination module 342 passes that question logic form 344 to a drop predicate module 346. The drop predicate module 346 drops the entire predicate and passes the resulting relaxed logic form 150 to the reasoning mechanism module 336, which performs the subsumption procedure once again. This process continues until either a proof is found, or the drop predicate module 346 drops the answer type predicate. If the answer type predicate is dropped, then the justification indicates no proof was found. The proof scoring module 340 scores each proof based on which axioms were used to arrive at the unification and which arguments and predicates were dropped if a relaxed question logic form was used. Justifications that indicate no proof was found are given the minimum score of 0.

Referring now to FIG. 5, the semantic calculus system 500 is presented which includes the semantic calculus module 502. In order to accurately answer judgment seeking questions, for example “Why is ‘The Tale of Genji’ famous?”, a question answering system requires a semantically enhanced logic prover which can extract unstated knowledge. The semantics detected in text include relations such as purpose, part-whole, manner, means, cause, synonymy, etc. In order to verify the semantic connectivity between a question and its candidate answer, the present invention requires a set of rule pairing axioms for the semantic relations which enables inference of unstated semantics/meaning from those detected in the candidate text.

Example of such axioms:
CAUSE_SR(x1,x2) & CAUSE_SR(x2,x3) CAUSE_SR(x1,x3). This semantic axiom states that if x1 causes x2 to happen and x2 causes x3, then we can say that x1 caused x3.
ATRIBUTE_SR(x1,x2) & ISA_SR(x3,x2)→ATRIBUTE_SR(x1,x3). Example: “John is a rich man.” The semantic relation tuples 38 extracted by the semantic parser module 36 are ATRIBUTE_SR(rich,man) and ISA_SR(John,man) and the new inferred relation is ATRIBUTE(rich,John).

The semantic combinations module 518 combines two semantic relations SR1 510 and SR2 512. These can come either from a predefined list of relations that can be identified in text or from the relations annotated in machine readable ontologies. The semantic combinations module 518 outputs a semantic axiom which asserts that the combination of SR1 510 and SR2 512 given the semantic operation op 516 is a new semantic relation SR1. This axiom 520 is given as input to a validation module 522 which passes it to a corpus 524 where the axiom's frequency and accuracy can be computed and outputted as the weight of the axiom 526. This score can be used by the modules that make use of the semantic axiom. The output of the semantic calculus module 502 is the weighted semantic axiom 528.

Referring now to FIG. 6, a context extraction system 540 is depicted which includes the context extraction module 542. The context extraction module takes as input the annotated parse trees 39 which go into a signal words detection module 544. This module passes the signal words 546 to the discovery of context types module 548 as well as to the context boundary detection module 552 which uses this input in addition to the list of context types 550 received from the discovery of context types module 548 to determine the contextual boundaries 544 and pass them to the context representer module 556. The context predicates are passed out of the context extraction module 542 to the logic form transformer module 132.

The present invention requires a context extraction module because of its technical advantages: enhance the logic representations of the natural language user query 56 and of the ranked answers 52 and, by adding context related axioms, it increases the correctness of the reasoning of the logic prover module 50.

The utilized contexts con be of one of the following types:
Objective: statements accepted as true. “The Earth is round.”
Subjective: the truth value of the statement depends on the speaker's credibility.
   Statements. “John said that Mary is beautiful.”
   Beliefs. “John thinks that Mary is beautiful.”
   Fictive
      dreams. “John dreams he's on a beach.”
      imagination
   Planning: plans, intentions. “John plans to buy a TV.”
   Volitional: desires. “John wants to stay longer.”
Probability, possibility, uncertainty, likelihood. “It might rain.”
Temporal “In October, the weather is cold.”
Spacial “In Alaska, there is a lot ofsnow.”
Domain
Conditional “If Mary comes, then John will go.”

Except for the objective context, all the other context restrict the interpretation of a statement within certain conditions (temporal, spacial, somebody's point of view, someone's beliefs, plans, desires, etc.). A context extraction module is required for a better understanding of the natural text. For example, let's consider the temporal context. Automated discovery of temporally ordered events requires detecting a temporal triple (S,E1,E2) which consists of a time dependent signal word (S) and its corresponding temporal event arguments, (E1) and (E2). For example, given the question “Which country declared independence in 1776?”, S=“in”, E1=“declared” and E2=“1776”; or given the sentence “After quickly decapitating the bird, Susan scalded the carcass.”, S=after, E1=decapitating” and E2=“scalded”. Detection of a temporal triple is complicated by two issues:
(1) Disambiguation of signal words: Not all signal words are unambiguously classified as time indicators.
   (a) He stood before the judge vs He proofread the manuscripts before mailing it to the publisher
   (b) He woke up at 10:00 vs He looked through the window at the rising sun
(2) Attaching events to signal words: Although some temporal events are found near their signal, many signals occur with their temporal events underspecified (non-local).
   (a) The problem was resolved after 4 hours of intensive maintenance but before anybody was harmed.

In the above example the signal word after easily attaches to resolved and 4 hours, while the second signal word, before has a non-local E1 reference (also resolved).

To address these issues machine learning is employed in two stages, first to recognize and disambiguate signals, and second to discover and attach temporal events to their signals. The predictive classifiers that result from learning are used to automatically detect temporal triples (signals with their attached temporal events) in natural language text.

The output of the Temporal Event Detection is transferred to the SUMO enhanced logical form module. The function of this module is to translate the natural language candidate sentences, marked up with time event chunks, to a temporally enhanced logic assertion. The input time event chunks are labeled with the class of the signal from the following list:
Sequence (before, after): E1 happened in full before E2
Containment (in, of): E1 is contained by E2
Overlap (at,as,on): An interval exists that is contained by E1 and E2
Right Open Interval(from, since): E1 is the left boundary of E2, right is undefined
Left Open Interval (to, until): E2 is the right boundary of E1, left is undefined
Closed Interval (for, all): E1 lasts for the duration of E2
Absolute Ordering (first, last): E1 has an ordering relative to E1, along with the parsed chunks identified as the time event arguments to the signal.

The knowledge representation for the temporally enhanced logic form is layered on top in the logic form creation module 162. From this structure temporally related SUMO predicates are generated based on hand coded interpretation rules for the signal classes. The purpose of the interpretation rules is to define an algorithm for assigning a signal word to a SUMO predicate and defining the manner in which the slots for the predicate are determined. Table 1 enumerates the signal classes, and the SUMO predicate corresponding to the interpretation rule.

Once the SUMO predicate is chosen, the arguments to the predicate are the event argument ids from the heads of the chunks passed as attachments to the signal expression. Since all temporal SUMO predicates operate on time intervals, absolute times stated in the text are translated into a pair of time point predicates to specify the begin and end of the interval. A detailed example follows for the text: That compares with about 531,000 arrests in 1993 before Operation Gatekeeper started. The temporal event recognizer disambiguates in and before as temporal signals, and classifies (1) in as a contain interval signal, and (2) before as a sequence interval signal. The Local Attachment and Signal Chaining algorithms then determine the time event arguments for each signal. The output triples are (S1:contain=in, E1 arrests, E2=1993) and (S2:before=before, E1=arrests, E2=started). Once the mapping for the temporally ordered events and the absolute time events are complete, the SUMO predicates are generated. Predicates that were derived from signal words replace the signals in the logical form. . . . 531 000 NN(x2) & arrest NN (x2) & 1993]N(x3) & Operation NN(x4) & Gatekeeper NN(x5) & nn NC(x6,x4,x5) & start VB(e2,x6,x10) & earlier(WhenFn(x2), WhenFn(e2)) & Time(BeginFn(x11), 1993, 1, 1, 0, 0, 0) & Time(EndFn(x11), 1993, 12, 31, 23, 59, 59) &during(WhenFn(x3), x11) & during(WhenFn(x2), x3)

| Signal Class | SUMO Logic |
|---|---|
| <S sequence, E1, E2> | earlier(E1,E2) |
| <S contain, E1, E2> | during(E1,E2) |
| <S overlap, E1, E2> | overlapsTemporally(E1,E2) |
| <S open_right, E1, E2> | meetsTemporally(E1,E2) |
| <S open_left, E1, E2> | meetsTemporally(E2,E1) |
| <S closed, E1, E2> | duration(E1,E2) |

The contextual information extracted by the context extraction module 542 also improves the reasoning performed by the logic prover module 50. For the temporal context, we add a SUMO knowledge base of temporal reasoning axioms that consists of axioms for a representation of time points and time intervals, Allen primitives, and temporal functions. Example: during is a transitive Allen primitive (during(TIME1, TIME2) & during(TIME2, TIME3)->during(TIME1, TIME3).Another example, for the conditional and planning contexts which are used to express events and objects that only occur in some hypothetical world, are the trigger rules which allow the prover module 50 to enter the context only if the preconditions of the context are met. Conditional contexts are simply triggered by the preconditions of their context. Planning contexts are triggered when there is evidence in the knowledge base that the plan was fulfilled. Thus, the contents of the planning context are the triggers for the planning context. So if John plans X, and later we find he executed X, then that planning context is enabled. Example: “John intends to meet Bill.” The planning context is represented as: planning_CTXT(p1,e1)->meet_VB(e1,x1,x2) & Bill_NN(x2) and its trigger axioms: precondition: meet_VB(e1,x1,x2)->planning_CTXT(p1,e1). Assumed contexts are an important part of the default reasoning implementation. The assume CTXT predicate indicates to the prover that it is to be assumed that the preconditions of a context have been met, unless there is evidence to the contrary. The single argument of the predicate references the context for which preconditions are to be assumed. Each context that is enabled with default reasoning should have an associated trigger rule where the antecedent is the assume CTXT predicate and the consequent is the appropriate context predicate. In the above example, we want to be able to reason by default that John's meeting occurs as planned. This is accomplished by making assume CTXT imply planning CTXT: assume CTXT(p1)->planning CTXT(p1,e1).

Referring now to FIG. 7, a logic selector system 570 is depicted which includes the logic selector module 572. The logic selector module 572 takes as an input the question logic form 134 and the answer logic forms 136 which are passed to the predicate analyzer module 574. This module outputs the predicate features 576 to the pick a logic module 578 which will output the selected logic 580.

Natural language is rich in implicit and explicit contexts in addition to default assumptions that humans intuitively capture in their mental process. For a machine such as a question answering system to perform the same task, a careful and precise knowledge encoding scheme is required, as well as accompanying reasoning mechanisms for contexts and defaults. This is why a first order logic reasoning mechanism is not always appropriate to use when trying the justify each candidate answer given the question. The present invention requires a logic prover that will adapt its inference mechanism based on the given input.

Below, we show the way in which a first logic prover can cope with default reasoning. Given the example “John plans to meet Bill” presented above, we need default reasoning to handle entering John's planning context. This is achieved by adding assume CTXT predicates to the knowledge base that do not contradict the currently inferred knowledge. The assume context assertions lift constrained facts out of their context and allow a logic prover module to reason within that context. Before assume CTXT predicates are added to the knowledge base, the logic prover module attempts to find new inferences derived from the question axiom. If one cannot be found, the default reasoning module incrementally adds assume CTXT predicates into the knowledge base for contexts in the knowledge base that have yet to be triggered. After each assumption predicate is inserted, the knowledge base is checked for inconsistencies with the newly added default knowledge. If the consistency check fails, the assumption is removed from the knowledge base. The module continues inserting assume CTXT predicates into the knowledge base until no contradictions are found or the set of assumptions is empty. Once this is the case, the prover reinserts the question axiom into the knowledge base and again checks for newly inferred knowledge inferred from the hypothetical. If no new inferences are derived, the module returns to assuming the preconditions of other contexts that have yet to be explored. This technique allows us to keep track of everything that has been assumed by the prover by simply examining the trace of the proof search for the assume CTXT predicate. This is a very important feature of the default reasoning module because it allows us to qualify our answers with the assumptions of the contexts. It would be incorrect to state that any assertions inferred from the assumed contexts are absolute facts.

In one embodiment of the present invention, a method for ranking answers to a natural language query comprises receiving natural language information at a first module, receiving lexical chains, axioms based on the natural language information and extended lexical information, semantic axioms which combine two or more semantic relations at the second module, and outputting a justification based on at least one of an equivalence of the natural language information, the equivalence including: a strict equivalence, and a relaxed equivalence.

The system 10 of the present invention utilizes software or a computer readable medium that comprises instructions for receiving natural language information at a first module, receiving lexical chains and axioms based on the natural language information and extended lexical information at the second module, receiving semantic axioms which combine two or more semantic relations and a selected logic at a third module and outputting a justification from the third module based on a relaxed semantic equivalence of the natural language information, wherein the natural language information is represented as predicates with arguments. The computer readable medium of further comprises marking arguments to be ignored at the third module, marking predicates to be ignored at the third module, outputting an empty justification if no unmarked predicates remain, and outputting an empty justification if all answer type predicates are dropped, wherein the answer type predicates are at least one of the predicates.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

What is claimed is:

1. A method for natural language question answering, comprising:
receiving a question logic form, at least one answer logic form, and extended lexical information by a first module;
outputting at least one contextual index to a second module; and
utilizing the contextual index by the second module to provide an answer.

2. The method of claim 1, comprising outputting at least one answer based on at least one previously ranked candidate answer associated with at least one of: the question logic form, the answer logic form, and the contextual index.

3. The method of claim 2, wherein the outputted answer includes at least one of: an exact answer, a phrase answer, a sentence answer, a multi-sentence answer.

4. The method of claim 3, comprising re-ranking the outputted answer based on the previously ranked candidate answer.

5. The method of claim 1, comprising outputting at least one answer justification based on at least one candidate answer associated with at least one of: the question logic form including at least one contextual index and the answer logic form including at least ones contextual index.

6. The method of claim 5, wherein the outputted answer justification includes at least one of: every contextual index used, question terms that unify with answer terms, predicate arguments dropped, predicates dropped, and answer extraction.

7. The method of claim 1, wherein the question logic form is related to the answer logic form.

8. The method of claim 1, wherein the utilized contextual index are at least one of a following index from a group consisting of:
Subjective context;
Beliefs context;
Fictive context;
Planning context;
Volitional context;
Probability, possibility, uncertainty, likelihood context;
Temporal context;
Spatial context;
Domain context; and
Conditional context.

9. The method of claim 1, wherein the contextual index are of a type are at least one of a following type from a group consisting of:
Subjective context;
Beliefs context;
Fictive context;
Planning context;
Volitional context;
Probability, possibility, uncertainty, likelihood context;
Temporal context;
Spatial context;
Domain context; and
Conditional context.

10. The method of claim 9, wherein the subjective type of contextual index is selected from the group of: statements, beliefs, fictive, planning and volitional.

11. A method for natural language question answering, comprising:
receiving a question logic form, at least one answer logic form, and extended lexical information by a first module;
outputting at least one semantic relation to a second module; and
utilizing the semantic relation by the second module to provide an answer.

12. The method of claim 11, wherein further comprising the step of outputting a combination of semantic relations.

13. The method of claim 12, further comprising the step of utilizing the combination of semantic relations to provide the answer.

14. The method of claim 11, wherein the semantic relation is selected from the group comprising:
Possession;
Instrument;
Associated-With/Other;
Kinship;
Location-Space;
Measure;
Property-Attribute Holder;
Purpose;
Synonymy-Name;
Agent;
Source-From;
Antonymy;
Temporal;
Topic;
Probability;
Depiction;
Manner;
Possibility;
Part-Whole;
Means;
Certainty;
Hyponymy;
Accompaniment-Companion;
Theme-Patient;
Entail;
Experiencer;
Result;
Cause;
Recipient;
Stimulus;
Make-Produce;
Frequency;
Extent;
Influence;
Predicate;
Causality;
Goal;
Justification;
Meaning; and
Belief.

15. The method of claim 14, wherein the semantic operation is selected from the group comprising:
reverse;
composition;
dominance;
union;
intersection; and
difference.

16. The method of claim 14, further comprising a semantic operation and two or more semantic relations to generate a semantic axiom.

17. The method of claim 16, wherein parsing operation is selected from the group comprising:
reverse;
composition;
dominance; and
union.

18. The method of claim 1, wherein the question logic form is based on natural language.

19. The method of claim 1, wherein the answer logic form is based on natural language.

20. The method of claim 11, comprising outputting at least one said answer based on at least one previously ranked candidate answer associated with at least one of: the question logic form including at least one semantic relation and the answer logic form including at least one semantic relation.

21. A method for natural language question answering, comprising:
receiving a question logic form, at least one answer logic form, and extended lexical information by a first module; and
adapting an inference mechanism and logic to provide an answer.

22. The method of claim 21, wherein the logic is first order logic.

23. The method of claim 21, wherein the logic is non-monotonic logic including default reasoning.

24. The method of claim 21, wherein the logic is description logic.

25. The method of claim 21, wherein the question logic form is based on natural language.

26. The method of claim 21, wherein the answer logic form is based on natural language.

27. A method for natural language question answering, comprising:
receiving a question logic form, at least one answer logic form, and extended lexical information by a first module; and
utilizing multi-modal logic to provide an answer.

28. The method of claim 27, wherein the multi-modal logic is based on at least one selected from the group consisting of:
semantic combination axioms;
contextual index information;
inference mechanism selector utilizing at least one logic selected from the group comprising;
first order logic;
non-monotonic logic, and
description logic.

29. The method of claim 28, wherein the modal logic is selected as a function of the question logic form.

30. The method of claim 29, wherein the modal logic is selected as a function of the answer logic form.

31. The method of claim 30, further comprising performing justification within the selected logic mode between the question logic form and the answer logic form using axioms.

32. The method of claim 31, wherein the used axioms are weighted semantic axioms.

33. The method of claim 27, wherein the question logic form and the answer logic form are based on natural language.

34. A natural language question answering system, comprising;
a first module configured to receive a question logic form, at least one answer logic form, and extended lexical information; and
a second module responsive to the first module and having a contextual index and configured to output an answer as a function of the question logic form and the contextual index.

35. A natural language question answering system, comprising;
a first module configured to receive a question logic form, at least one answer logic form, and extended lexical information; and
a second module responsive to the first module and configured to utilize a semantic relation of the question logic form to output an answer.

36. A natural language question answering system, comprising;
a first module configured to receive a question logic form, at least one answer logic form, and extended lexical information; and
a second module responsive to the first module and configured to utilize an inference mechanism and logic to provide an answer.

37. A natural language question answering system, comprising;
a first module configured to receive a question logic form, at least one answer logic form, and extended lexical information; and
a second module responsive to the first module and configured to utilize multi-modal logic to provide an answer.

38. A computer readable medium including instructions for:
receiving a question logic form, at least one answer logic form, and extended lexical information by a first module;
outputting at least one contextual index to a second module; and
utilizing the contextual index by the second module to provide an answer.

39. A computer readable medium including instructions for:
receiving a question logic form, at least one answer logic form, and extended lexical information by a first module;
outputting at least one semantic relation to a second module; and
utilizing the semantic relation by the second module to provide an answer.

40. A computer readable medium including instructions for:
receiving a question logic form, at least one answer logic form, and extended lexical information by a first module; and
adapting an inference mechanism and logic to provide an answer.

41. A computer readable medium including instructions for:
receiving a question logic form, at least one answer logic form, and extended lexical information by a first module; and
utilizing multi-modal logic to provide an answer.
